(19) United States
(12) Patent Application Publication
(10) Pub. No.: US 2005/0018890 A1
(43) Pub. Date: Jan. 27, 2005

(54) Segmentation of left ventriculograms using boosted decision trees

(76) Inventors: John Alan McDonald, Seattle, WA (US); Florence H. Sheehan, Mercer Island, WA (US)

Correspondence Address: LAW OFFICES OF RONALD M. ANDERSON, Suite 507, 600 - 108th Avenue N.E., Bellevue, WA, 98004, US

(21) Appl. No.: 10/626,028

(22) Filed: Jul. 24, 2003

(51) Int. Cl. G06K 9/00; G06K 9/48

(52) U.S. Cl. 382/128; 382/199

(57) ABSTRACT

An automated method for determining the location of the left ventricle at user-selected end diastole (ED) and end systole (ES) frames in a contrast-enhanced left ventriculogram. Locations of a small number of anatomic landmarks are specified in the ED and ES frames. A set of feature images is computed from the raw ventriculogram gray-level images and the anatomic landmarks. Variations in image intensity caused by the imaging device used to produce the images are eliminated by de-flickering the image frames of interest. Boosted decision-tree classifiers, trained on manually segmented ventriculograms, are used to determine the pixels that are inside the ventricle in the ED and ES frames. Border pixels are then determined by applying dilation and erosion to the classifier output. Smooth curves are fit to the border pixels. Display of the resulting contours of each image frame enables a physician to more readily diagnose physiological defects of the heart.

### FIELD OF THE INVENTION

The present invention generally pertains to a system and method for determining a boundary or contour of the left ventricle of an organ such as the human heart based upon image data, and more specifically, is directed to a system and method for determining the contour of an organ based on processing image data, such as contrast ventriculograms, and applying de-flickering to the image data to improve the quality of the determination.

### BACKGROUND OF THE INVENTION

Contrast ventriculography is a procedure that is routinely performed in clinical practice during cardiac catheterization. Catheters must be intravascularly inserted within the heart, for example, to measure cardiac volume and/or flow rate. Ventriculograms are X-ray images that graphically represent the inner (or endocardial) surface of the ventricular chamber. These images are typically used to determine tracings of the endocardial boundary at end diastole (ED), when the heart is filled with blood, and at end systole (ES), when the heart is at the end of a contraction during the cardiac cycle. By manually tracing the contour or boundary of the endocardial surface of the heart at these two extremes in the cardiac cycle, a physician can determine the size and function of the left ventricle and can diagnose certain abnormalities or defects in the heart.

To produce a ventriculogram, a radio opaque contrast fluid is injected into the left ventricle (LV) of a patient's heart. An X-ray source is aligned with the heart, producing a projected image representing, in silhouette, the endocardial region of the left ventricle of the heart. The silhouette image of the LV is visible because of the contrast between the radio opaque fluid and other surrounding physiological structure. Manual delineation of the endocardial boundary is normally employed to determine the contour, but this procedure requires time and considerable training and experience to accomplish accurately. Alternatively, a medical practitioner can visually assess the ventriculogram image to estimate the endocardial contour. Clearly, an automated border detection technique that can produce more accurate and reproducible results than visual assessment and in much less time than the manual evaluation would be preferred.

Several automatic border detection algorithms have been developed to address the above-noted problem. These algorithms fall into two major groups. In one group, edge detection methods are used to directly determine the location of the endocardial boundary. In the other group, pixel classification is first used to determine the pixels that are inside the left ventricle and those that are outside in chosen image frames, typically an ED frame and the following ES frame. The methods used in this second group of algorithms typically have a common three step structure, as follows: (1) pre-processing (or feature extraction), in which raw ventriculogram data are transformed into the inputs required by a pixel classifier, (2) pixel classification; and, (3) post-processing (or curve fitting), in which the classifier output is transformed into endocardial boundary curves.

In U.S. Pat. Nos. 5,570,430, and 5,734,739, Sheehan et al. present methods for ventriculogram segmentation with this same basic three step structure. These inventions used older classifier technology (essentially, “Naïve Bayes”), which requires reducing the information in the original 300-400 ventriculogram images to approximately four feature images. This approach limits the accuracy of the classifier output, requiring elaborate post-processing in an attempt to compensate for the severe defects in pixel classification. The classifier and post-processing used in these previous inventions were very expensive to train, requiring about two months on computers using an Intel Corporation 1.0 GHz Pentium III™ processor.

Current methods for classification, such as boosted CART decision trees enable the use of many more features than Naïve Bayes. In addition, the modern classifiers can be trained much more quickly than the classifier and post-processing of the previous inventions, requiring about eight hours on a computer using the 1.0 GHz Pentium III™ processor, with a feature set containing on the order of 100 feature images. The advantages of modern classifiers make it possible to do a series of trial-and-error experiments to determine a feature set that, in combination with the modem classifiers, gives much more accurate pixel classification, with error rates of about 1%. Use of the more effective classifier algorithms that are now available should enable accurate endocardial boundary curves to be determined by simple curve fitting methods.

A preferred approach for pixel classification uses boosted decision trees, as described by Jerome Friedman et al. (Additive Logistic Regression, Annals of Statistics 28:337-374, 2000). This method is derived from work of Yoav Freund and Robert Schapire (Experiments with a new boosting algorithm, Proceedings of the Ninth Annual Conference on Computational Learning Theory 325-332, 1996; A decision-theoretic generalization of online learning and an application to boosting, Journal of Computer and System Sciences 55:119-139, 1997; and U.S. Pat. No. 5,819,247). Freund et al. disclose an approach to classification based on boosting “weak hypotheses.” Friedman et al. show that boosting is a specific instance of a class of prior art methods known as “Additive Models.” In addition, the method of Friedman et al. uses decision trees as the, “weak hypotheses” to be boosted, whereas Freund et al. use neural nets, which are somewhat more difficult to implement and not particularly applicable to the present problem. Also, U.S. Pat. No. 5,819,247 selects a subset of the training data. It does not appear that it is necessary to employ a subset to perform the classifier algorithm like that used in the method presented by Friedman et al.

Freund (U.S. Pat. No. 6,456,993) discloses a method for using boosting in the context of creating decision tree classifiers. The invention disclosed in the patent uses boosting in the course of creating a single (large) decision tree. In contrast, the method described by Friedman et al. uses boosting to create a decision forest, i.e., a collection of many (typically more than 500) small (typically 4-8 node) decision trees. The individual decision trees are created without boosting, using CART or a similar approach. Boosting is used to re-weight the training data before each new tree is constructed and to combine the outputs of the trees into a single classification.

Schapire and Singer (U.S. Pat. No. 6,453,307) disclose a method for using boosting to do multi-class, multi-label information categorization. In independent Claims 1 and 20 of that patent, at least one of the samples in the training data is required to have more than one class label. In the method described by Friedman et al., all training data carry a single class label.

Pixel classification using boosted decision trees can be further improved using a two-stage approach to classification similar to that of Chandrika Kamath, Sailes K. Sengupta, Douglas Poland, and Jopin A. H. Futterman, as described in their article entitled, “On the use of machine vision techniques to detect human settlements in satellite images,” which was published in Image Processing: Algorithms and System II, SPIE Electronic Imaging, Santa Clara, Calif., Jan. 22, 2003.

In addition, the surface fitting method of U.S. Pat. No. 5,889,524 (Sheehan et al.) should be usable for the curve fitting step, restricting the three-dimensional (3-D) method disclosed therein to two-dimensions (2-D), and using a surface model that consists of a single curve.

One of the other problems that must be addressed in automatically detecting borders from ventriculogram image data relates to an apparent lack of stability of the image brightness caused by fluctuations in the imaging equipment. Since the border detection algorithms require processing images in regard to gray scale data, the fluctuations in image intensity caused by the imaging equipment must be compensated. Accordingly, an approach is required to process the images so that the effects of such flickering in the image intensity are substantially eliminated.

### SUMMARY OF THE INVENTION

In accordance with the present invention, a method is defined for determining the location of the left ventricle of the heart in a contrast-enhanced left ventriculogram, at user-specified ED and ES image frames. The method uses a subset of the image frames in the ventriculogram, during which the heart has completed several heart beats. A human operator must specify the locations of a small number of anatomic landmarks in the chosen ED and ES frames. The method has three main steps: (1) feature calculation, (2) pixel classification, and (3) curve fitting.

More specifically, a method in accord with the present invention includes the steps of choosing ED and ES image frames to be segmented from the sequence of image frames. Those of ordinary skill in the art will understand that “segmenting” an image frame in this case refers to determining whether pixels in the image frame are inside or outside the contour or border of the left ventricle. The next step provides for indicating anatomic landmarks in the ED and ES image frames that were chosen. A pre-determined set of feature images are calculated from the sequence of image frames, the ED and ES image frames, and the anatomic landmarks. The step of calculating includes the step of de-flickering the image frames to substantially eliminate variations in intensity introduced into the image data when the left ventriculogram was produced. A pixel classifier is trained for a given set of feature images, using manually segmented ventriculograms produced for other left ventriculograms as training data. Boundary pixels are then extracted by using the pixel classifier to classify pixels that are inside and outside of the left ventricle in the ED and ES image frames. Finally, a smooth curve is fitted to the boundary pixels extracted from the classifier output for both the ED and ES image frames, to indicate the contour of the left ventricle for ED and ES portions of the cardiac cycle.

The step of calculating the pre-determined set of feature images preferably includes the step of masking the ventriculogram image frames with a mask that substantially excludes pixels in the ventriculogram image frames that are outside the left ventricle.

The step of de-flickering preferably comprises the steps of applying a mask to the sequence of image frames, determining a gray-level median image, and using repeated median regression to produce de-flickered image frames.

The pixel classifier preferably comprises two stages, including a first stage classifier and a second stage classifier that operate sequentially, so that an output of the first stage classifier is input to the second stage classifier. The method also preferably includes the step of spatially blurring the output of the first stage for input to the second stage. Also, each of the first and the second classifier stages includes separate ED and ES classifiers, and the ED and ES classifiers comprise decision trees. In a preferred embodiment, the ED and ES classifiers are boosted decision trees that use an AdaBoost.M1 algorithm for classifying images.

The step of fitting the smooth curve preferably includes the step of determining the boundary pixels using dilation and erosion. This step preferably includes the steps of generating a control polygon for a boundary of the left ventricle in the contrast-enhanced left ventriculogram, with labels corresponding to the anatomic landmarks. The control polygon is subdivided to produce a subdivided polygon having an increased smoothness, and the subdivided polygon is rigidly aligned with the anatomic landmarks of the left ventricle. The subdivided polygon is then fitted with the ED and ES image frames and the anatomic landmarks, to produce a reconstructed border of the left ventricle for ED and ES.

Another aspect of the present invention is directed to a system for automatically determining a contour of a left ventricle of a heart, based upon digital image data from a contrast-enhanced left ventriculogram, said image data including a sequence of image frames of the left ventricle made over an interval of time during which the heart has completed more than one cardiac cycle. The system includes a display, a nonvolatile storage for the digital image data and for machine language instructions used in processing the digital image data, and a processor coupled to the display and to the nonvolatile storage. The processor executes the machine language instructions to carry out a plurality of functions that are generally consistent with the steps of the method described above.

### BRIEF DESCRIPTION OF THE DRAWING FIGURES

The foregoing aspects and many of the attendant advantages of this invention will become more readily appreciated as the, same becomes better understood by reference to the following detailed description, when taken in conjunction with the accompanying drawings, wherein:

FIG. 1 is flow chart showing an overview of the process steps employed in the present invention to determine the contour of a LV, at user-specified ED and ES frames;

FIG. 2 is cross-sectional view of a human heart, illustrating the shape of the LV;

FIG. 3 is a flow chart showing the steps used in calculating feature images from raw ventriculogram image frames and user-supplied anatomic landmarks;

FIG. 4 is a flow chart showing the steps used in de-flickering;

FIG. 5 is a flow chart illustrating the steps used for pixel classification;

FIG. 6 is a flow chart illustrating the steps used for curve fitting; and

FIG. 7 is a schematic functional block diagram of a computing device suitable for implementing the present invention.

### DESCRIPTION OF THE PREFERRED EMBODIMENT

Object of the Method Used in the Present Invention

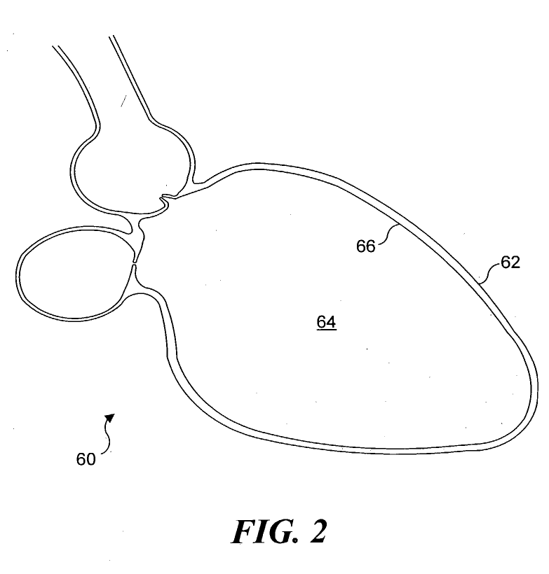

Referring now to FIG. 2, a cross-sectional view of a portion of a human heart 60 corresponding to a projection angle typically used for recording ventriculograms has a shape defined by its outer surface 62. Prior to imaging a LV 64 of heart 60, the radio opaque contrast material is injected into the LV so that the plurality of image frames produced using the X-ray apparatus include a relatively dark area within LV 64. However, those of ordinary skill in the art will appreciate that in X-ray images of the LV, the dark silhouette bounded by the contour of an endocardium (or inner surface) 66 of LV 64 is not clearly delineated. The present method processes the image frames produced with the X-ray source to obtain a contour for each image frame that closely approximates the endocardium of the patient's LV.

During the cardiac cycle, the shape of LV 64 varies and its cross-sectional area changes from a maximum at ED, to a minimum at ES. The cross-sectional area and the shape defined by the contour of the endocardium surface change during this cycle as portions of the wall of the heart contract and expand. By evaluating the changes in the contour of the LV from image frame to image frame over one or more cardiac cycles, a physician can diagnose organic problems in the patient's heart, such as a weakened myocardium (muscle) along a portion of the wall of the LV. These physiological dysfunctions of the heart are more readily apparent to a physician provided with images clearly showing the changing contour of the heart over the cardiac cycle. The physician is alerted to a possible problem if the contour does not change shape from frame to frame in a manner consistent with the functioning of a normal heart. For example, if a portion of the LV wall includes a weakened muscle, the condition will be evident to a physician studying the relative changes in the contour of the LV in that portion of the wall, compared to other portions, since the portion of the endocardium comprising the weakened muscle will fail to contract over several image frames during systole in a normal and vigorous manner. At the very least, physicians are interested in comparing the contours of the LV at ED versus ES. Thus, a primary emphasis of the present invention is in automatically determining the contour of the LV within the ED and ES image frames, although the contour can automatically be determined for other image frames during a cardiac cycle in the same manner.

The capability to automatically determine the contour of the LV immediately after the images are acquired can enable a physician to more readily evaluate the condition of the heart during related medical procedures. It is expected that the present method should produce contours of the LV at chosen ED and ES frames, with accuracy at least equal to that of an expert in evaluating such images, and should accomplish this task substantially faster than a human expert. Moreover, the present invention ensures that the contour is accurately determined by relating a position and orientation of the patient's heart in the image data to an anatomical feature, namely, the aortic valve plane, although other anatomic landmarks can be used instead, or in addition.

Details of the Method

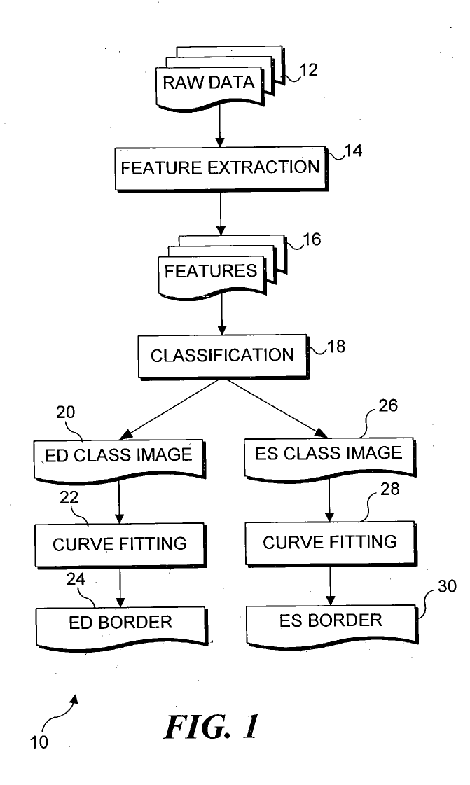

An overview of the steps involved in automatically determining the contour of the LV is shown in a flow chart 10 of FIG. 1. The input for the process that is used to determine the contour of the LV is labeled raw data” in block 12 of FIG. 1. The raw data include: (a) user-specified end ED and ES image frames; (b) a subset of the image frames for the ventriculogram, during which the heart has completed several heart beats, determined from the user-chosen ED and ES frames; and (c) user-specified locations for a small number of anatomic landmarks in the chosen ED and ES frames. In a step 14, labeled feature extraction, a set 16 of feature images is computed from the raw ventriculogram gray-level images and the anatomic landmarks. In a step 18, labeled classification, pixel classifiers, trained on manually segmented ventriculograms, are used to determine the pixels that are inside the ventricle for an ED class image 20 and an ES class image 26. Smooth curves are then fit to the classifier output in a step 22 (for the ED class image) and in a step 28 (for the ES class image), each labeled curve fitting. Resulting semi-automatically determined ED border 24 and ES border 30 can be displayed to enable a physician to more readily diagnose physiological defects of the heart.

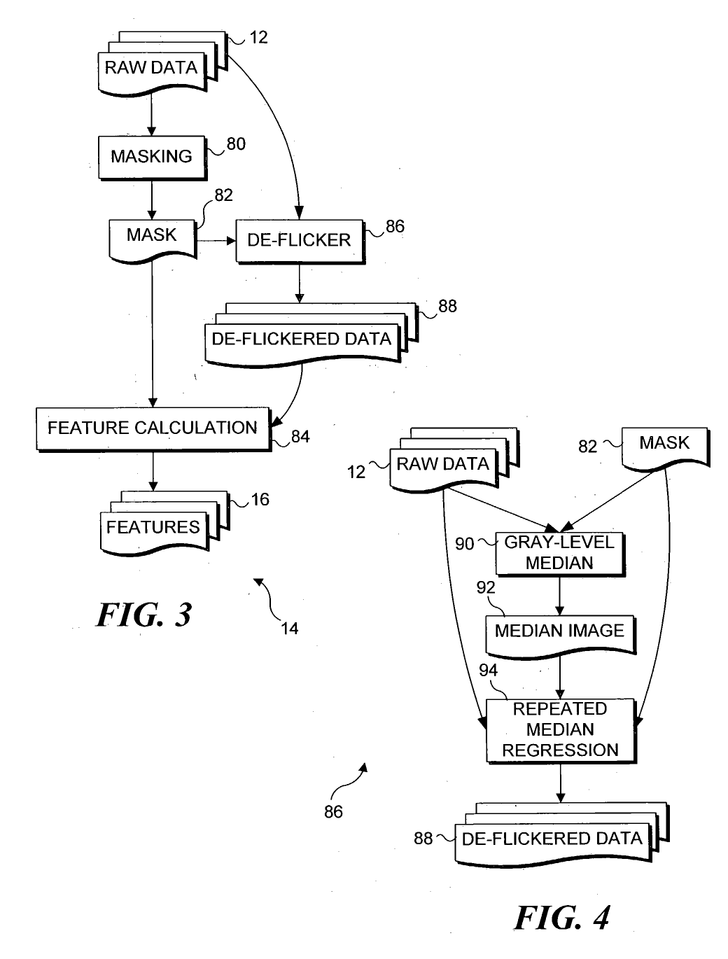

The feature extraction in step 14 is illustrated in more detail in FIG. 3. A mask image 82 is first created in a step 80 labeled masking. It is preferable to automatically produce a mask for use in this portion of the procedure, but the present embodiment employs a manually created mask. A brief explanation will provide clarification as to why it is preferable to employ a mask to reduce the processing overhead and improve the speed with which the present invention is executed using a computing device, as explained further below. Ventriculograms typically have a fairly large outer region of non-informative black or dark gray pixels. Some of these pixels are due to the X-ray imaging device/software, which creates a square 512×512 pixel image, even when the actual X-ray data cover a smaller, often non-rectangular region. In order to minimize the X-ray dose to a patient, shutters may be placed in the image frame, which further obscure the outer parts of the image. Some of the classifier features rely on gray level statistics being similar from patient to patient. To make these statistics as comparable as possible, mask images are constructed.

Only pixels within the mask are then used in the subsequent steps.

A preferred embodiment of the present invention uses a simple fixed, octagonal mask 82 for all patients. This mask is determined in a step 80 by manually examining all the ventriculograms in the training data and subjectively choosing a mask region that includes all ventricle pixels, while excluding as many non-informative pixels that are clearly outside the ventricle as possible. As noted above, it is contemplated that the mask can alternatively be automatically developed from image frames by applying a suitable algorithm, as will be well known to those of ordinary skill in the art.

Mask image 82 and raw data 12 are then passed to a step 86 labeled de-flicker, which adjusts the brightness and contrast of the raw image frames to remove non-informative gray-level variation introduced by the imaging device used to produce the raw images, producing de-flickered data 88. Ventriculogram image sequences often have significant flicker—instantaneous jumps in overall brightness due to instability in the imaging device and unrelated to useful gray level variation from frame to frame that relate to changes due to the shape of the heart during the cardiac cycle. The jump in brightness or intensity may be complete between two frames, but it is often the case that there are one or more frames in which the upper quarter or so of the image is brighter or darker overall, compared to the remainder of the frame. Many of the important classifier features 16 are estimates of rates of gray level change determined during a feature calculation step 84. The procedure used to determine these features is seriously disturbed by any significant flicker that is produced by the imaging device. Accordingly, it is important to remove flicker or intensity variations caused by the imaging device.

With reference to FIG. 4, to remove flicker, the present invention applies mask 82 to a subset of the image frames comprising raw data 12 that are generally grouped around the ED and ES image frames. In a step 90, for each of the image frames in the subset, at each pixel location within the region not excluded by the mask, a median gray-level is determined. This step thus produces a median image 92 in which the median gray-levels are assigned to the pixels likely to be within the ventricle. The present embodiment preferably uses repeated median regression of each image frame in regard to median image frame 92, as illustrated in a step 94 of FIG. 4. As is known in the art, repeated median regression is highly resistant, and will ignore up to one-half of the data in determining its fit, which enables the technique to fit to the constant part of an image, while substantially ignoring the pixels in the image that change due to ventricle motion, producing de-flickered data 88. It is the variation of the intensity due to ventricle motion remaining in the de-flickered data that is of interest in determining the contours of the ventricle at ED and ES.

After de-flickering is complete, the mask, the de-flickered images, and the raw data (including the images that have not been de-flickered) are passed to step 84, labeled feature calculation, in FIG. 3, which creates the actual feature images 16. The specific set of feature images used in a preferred embodiment was determined by a series of trial and error experiments which sought to achieve a balance between classification accuracy and computation time.

There are three main kinds of features, including DICOM (i.e., the Digital Imaging and Communications in Medicine image format standard) property features, geometry features, and gray level features. DICOM property features are images with a single gray level that are used: to code one or more of attributes found originally in a DICOM image header. For example, DICOM XA (X-ray angiography images) must have a PixelIntensityRelationship attribute, which specifies how measured X-ray intensities are translated into pixel gray levels. Allowed values for PixelIntensityRelationship are LIN, LOG, and DISP. The PixelIntensityRelationship feature image has a single gray level, which codes one of these three values (e.g., 2, 4, and 8).

Geometry features indicate a pixel's location in both absolute terms and in coordinates relative to the user-specified anatomic landmarks. A simple absolute geometry feature has a gray level proportional to each pixel's x coordinate. A simple relative geometry feature has gray levels proportional to the distance from the pixel to one of the user-specified anatomic landmarks.

A gray level feature is computed by applying a sequence of standard image processing operations to a subset of either the raw (un-de-flickered) or de-flickered images. There are several subsets of gray level features, as follows:
(a) ED and ES frame subsets are chosen, resulting in four image sequences, including raw ED, raw ES, de-flickered ED, and de-flickered ES.

(b) First differences of each of the four sequences are computed, resulting in four more image sequences, including: D(raw, ED), D(raw ES), D(de-flickered ED), and D(de-flickered ES). The first difference of a sequence of N images is a sequence of N-1 images created by subtracting each image (i.e., the gray levels of the pixels) in the original sequence from the subsequent image (i.e., from the gray levels of the corresponding pixels of the subsequent image) in the sequence.

(c) Per-pixel gray level statistics are computed for each of the eight image sequences. Different statistics may be used for different sequences. An example is the maximum of the first differences of the de-flickered ED images. For each pixel in this feature image, the gray level is proportional to the maximum increase in brightness in that pixel between any pair of succeeding de-flickered ED images. After the gray level statistic images are computed, the eight image sequences are discarded. Some of the per-pixel statistics images are retained in the final feature image set, and some are used only as intermediate data in computing other features.

(d) Some of the per-pixel statistics images are adjusted to make their gray-level distributions more comparable from ventriculogram to ventriculogram. In a preferred embodiment, this step is done using histogram equalization.

(e) Some of the per-pixel statistics images and some of the equalized images are blurred to enable the classifier to produce smoother output. Blurring a feature image causes each pixel to be more similar to its neighboring pixels. In a preferred embodiment, blurring is done using a “running means algorithm,” i.e., the gray level of each pixel is replaced with the mean of the gray levels of the pixels in a square window centered on the current pixel to be smoothed. The running means algorithm is optionally repeated to give still smoother output.

As shown in FIG. 1, the feature images thus computed are passed to step 18, labeled classification, which determines the pixels that are inside and outside the ventricle in the chosen ED and ES images. Details of the classification step are shown in FIG. 5.

The classification step uses a two-stage strategy. The concept applied in this step is that a Stage0 ED class image 102 and a Stage0 ES class image 106 that are respectively output by a preliminary (Stage0) ED classifier 100 and a preliminary (Stage0) ES classifier 104 can be used in computing additional features for the following (Stage1) ED and ES classifiers. This two-stage strategy enables a preliminary classification of pixels at ED to be used in the final classification of pixels at ES, and vice versa. Spatially blurring Stage0 class images in a step 108, which smoothes their contours, enables Stage1 classifiers to use the Stage0 classification of neighboring pixels, producing more spatially coherent results. Stage1 features 110 include spatially blurred Stage0 class images, as well as features 16, which were described above.

For implementing the four inner Stage0 and Stage1 classifiers, a preferred embodiment uses decision trees boosted with the AdaBoost.M1 algorithm. The Stage0 classifiers are trained in the usual way, using a training set of manually segmented ventriculograms.

A preferred embodiment uses greedy training for a Stage1 ED classifier 112 and a Stage1 ES classifier 116. Greedy training is defined as follows. A given set of data is used to train the Stage0 classifiers. The Stage0 classifiers are then used to classify the same training data to create the features used to train the Stage1 classifier. Because the Stage0 classifiers are used on their own training data, the results will be optimistically biased. The Stage0 class images will appear to be better predictors of the true classes than they really are, and will get higher weight in the Stage1 classifiers than they should. An alternative is to use cross-validation to train the Stage1 classifiers, which would be expected to give more accurate results, but would increase the training time by a factor of about 5-10.

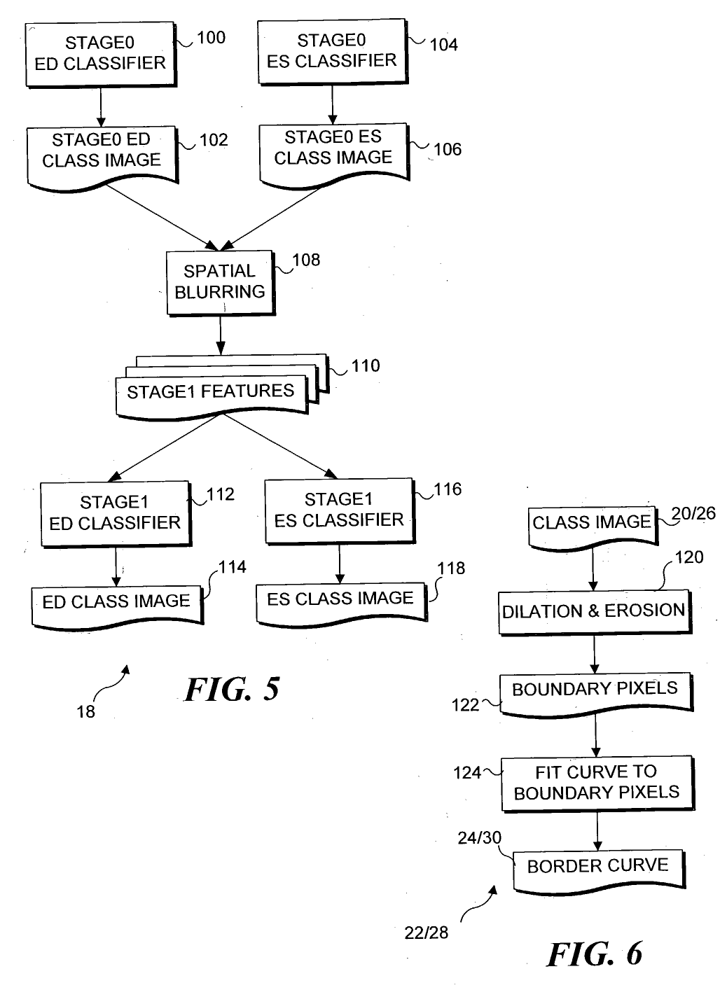

The classification step produces two binary class images, one for the chosen ED frame—an ED class image 114, and one for the ES frame—an ES class image 118. These class images are passed independently to steps 22 and 28, both labeled the curve fitting in FIG. 1. The curve fitting process is described in greater detail in FIG. 6.

As indicated in FIG. 6, which is applicable to both steps 22 and 28, in a step 120, pixels close to the endocardial boundary (or boundary pixels 122) are identified using the standard image processing operations of dilation and erosion, which are well known in the art. These boundary pixels are combined with the user-specified anatomic landmarks to create several sets of labeled 2-D point data. In a step 124, a curve is then fit to the boundary pixels or point data using the surface fitting method taught by commonly assigned U.S. Pat. No. 5,889,524, yielding the border curves 24/30, at ED and ED, respectively. This approach restricts the 3-D method to 2-D, and uses a surface model that includes a single curve. The drawings and specification of U.S. Pat. No. 5,889,524, which is attached hereto as Appendix A, are hereby specifically incorporated herein by reference to provide further details of this procedure.

Exemplary Computing System for Implementing the Present Invention

It will be understood that the method described above is defined by machine language instructions comprising a computer program. The computer program can readily be stored on memory media such as floppy disks, a computer disk-read only memory (CD-ROM), a DVD or other optical storage media, or a magnetic storage media such as a tape, for distribution and execution by other computers. It is also contemplated that the program can be distributed over a network, either local or wide area, or over a network such as the Internet. Accordingly, the present invention is intended to include the steps of the method described above, as defined by a computer program and distributed for execution by a processor in any appropriate computer working alone or with one or more other processors.

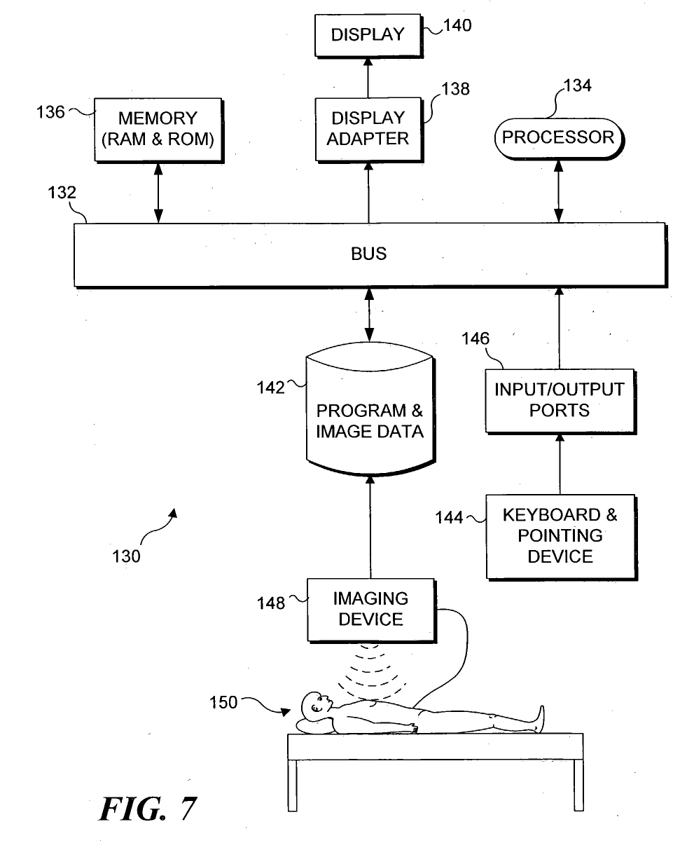

Basic functional components of an exemplary computing device for executing the steps of the present invention are illustrated in FIG. 7. As shown therein, a computing device 130 includes a data bus 132 to which a processor 134 is connected. Also connected to bus 132 is a memory 136, which includes both random access memory (RAM) and read only memory (ROM). A display adapter 138 is coupled to the bus and provides signals for driving a display 140.

Machine language instructions comprising one or more programs, and image data are stored in a non-volatile storage 142, which is also coupled to bus 132 and therefore, is accessible by processor 134. A keyboard and/or pointing device (such as a mouse) are generally denoted by reference numeral 144 and are connected to bus 132 through a suitable input/output port 146, which may for example, comprise a personal system/2 (PS/2) port, or a serial port, or a universal serial bus (USB) port, or other type of data port suitable for input and output of data.

An imaging device 148, such as a conventional X-ray machine, is shown imaging a patient 150 to obtain imaging data that are processed by the present invention after being input to nonvolatile storage 142. However, it should be emphasized that the imaging device is not part of the exemplary processing system. The image data may be independently produced at a different time and separately supplied to nonvolatile storage 142 either over a network or via a portable data storage medium. System 130 is only intended as an exemplary system, and it will be understood that various other forms of computing devices can be employed in the alternative to process the image data in accord with the present invention to produce contours for the cardiac ED and ES of patient. One of the advantages of the present invention is that it can be implemented on a reasonable cost computing device in real time, enabling medical personnel to quickly view automatically produced ED and ES contours of a patient's ventricle. This facility enables decisions regarding a patient to be quickly made without the delay typically incurred when manual techniques or more time consuming automatic techniques are employed to display the ED and ES contours.

Although the present invention has been described in connection with the preferred form of practicing it, those of ordinary skill in the art will understand that many modifications can be made thereto within the scope of the claims that follow. Accordingly, it is not intended that the scope of the invention in any way be limited by the above description, but instead be determined entirely by reference to the claims that follow.

1. A method for automatically determining a contour of a left ventricle of a heart, based upon digital image data from a contrast-enhanced left ventriculogram, said image data including a sequence of image frames of the left ventricle made over an interval of time during which the heart has completed more than one cardiac cycle, said method comprising the steps of:
(a) from the sequence of image frames, choosing end diastole (ED) and end systole (ES) image frames to be segmented;
(b) indicating anatomic landmarks in the ED and ES image frames that were chosen;
(c) calculating a pre-determined set of feature images from the sequence: of image frames, the ED and ES image frames, and the anatomic landmarks, the step of calculating including the step of de-flickering the image frames to substantially eliminate variations in intensity introduced into the image data when the left ventriculogram was produced;
(d) training a pixel classifier for a given set of feature images, using manually segmented ventriculograms produced for other left ventriculograms as training data;
(e) extracting boundary pixels by using the pixel classifier to classify pixels that are inside and outside of the left ventricle in the ED and ES image frames; and
(f) fitting a smooth curve to the boundary pixels extracted from the classifier output for both the ED and ES image frames, to indicate the contour of the left ventricle for ED and ES portions of the cardiac cycle.

2. The method of claim 1, wherein the step of calculating the pre-determined set of feature images includes the step of masking the ventriculogram image frames with a mask that substantially excludes pixels in the ventriculogram image frames that are outside the left ventricle.

3. The method of claim 1, wherein the step of de-flickering comprises the steps of:
(a) applying a mask to the sequence of image frames;
(b) determining a gray-level median image; and
(c) using repeated median regression to produce de-flickered image frames.

4. The method of claim 1, wherein the pixel classifier includes two stages, including a first stage classifier and a second stage classifier that operate sequentially, so that an output of the first stage classifier is input to the second stage classifier.

5. The method of claim 4, further comprising the step of spatially blurring the output of the first stage for input to the second stage.

6. The method of claim 4, wherein each of the first and the second classifier stages includes separate ED and ES classifiers.

7. The method of claim 6, wherein the ED and ES classifiers comprise decision trees.

8. The method of claim 6, wherein the ED and ES classifiers are boosted decision trees that use an AdaBoost.M1 algorithm for classifying images.

9. The method of claim 1, wherein the step of fitting the smooth curve includes the step of determining the boundary pixels using dilation and erosion.

10. The method of claim 1, wherein the step of fitting the smooth curve includes the steps of:
(a) generating a control polygon for a boundary of the left ventricle in the contrast-enhanced left ventriculogram, with labels corresponding to the anatomic landmarks;
(b) subdividing the control polygon to produce a subdivided polygon having an increased smoothness;
(c) rigidly aligning the subdivided polygon with the anatomic landmarks of the left ventricle; and
(d) fitting the subdivided polygon with the ED and ES image frames and the anatomic landmarks, to produce a reconstructed border of the left ventricle for ED and ES.

11. A system for automatically determining a contour of a left ventricle of a heart, based upon digital image data from a contrast-enhanced left ventriculogram, said image data including a sequence of image frames of the left ventricle made over an interval of time during which the heart has completed more than one cardiac cycle, comprising:
(a) a display;
(b) a nonvolatile storage for the digital image data and for machine language instructions used in processing the digital image data;
(c) a processor coupled to the display and to the nonvolatile storage, said processor executing the machine language instructions to carry out a plurality of functions, including:
(i) from the sequence of image frames, choosing end diastole (ED) and end systole (ES) image frames to be segmented;
(ii) indicating anatomic landmarks in the ED and ES image frames that were chosen;
(iii) calculating a pre-determined set of feature images from the sequence of image frames, the ED and ES image frames, and the anatomic landmarks, the step of calculating including the step of de-flickering the image frames to substantially eliminate variations in intensity introduced into the image data when the left ventriculogram was produced;
(iv) training a pixel classifier for a given set of feature images, using manually segmented ventriculograms produced for other left ventriculograms as training data;
(v) extracting boundary pixels by using the pixel classifier to classify pixels that are inside and outside of the left ventricle in the ED and ES image frames; and
(vi) fitting a smooth curve to the boundary pixels extracted from the classifier output for both the ED and ES image frames, to indicate the contour of the left ventricle for ED and ES portions of the cardiac cycle.

12. The system of claim 11, wherein the machine instructions further cause the processor to mask the ventriculogram image frames with a mask that substantially excludes pixels in the ventriculogram image frames that are outside of a left ventricle.

13. The system of claim 11, wherein the machine instructions de-flicker the image frames by:
(a) applying a mask to the sequence of image frames to substantially exclude pixels that are outside of a left ventricle;
(b) determining a gray-level median image; and
(c) using repeated median regression to produce de-flickered image frames.

14. The system of claim 11, wherein the pixel classifier includes two stages, including a first stage classifier and a second stage classifier that operate sequentially, so that an output of the first stage classifier is input to the second stage classifier.

15. The system of claim 14, wherein the machine instructions further cause the processor to spatially blur the output of the first stage for input to the second stage.

16. The system of claim 14, wherein each of the first and the second classifier stages includes separate ED and ES classifiers.

17. The system of claim 16, wherein the ED and ES classifiers comprise decision trees.

18. The system of claim 16, wherein the ED and ES classifiers are boosted decision trees that use an AdaBoost.M1 algorithm for classifying images.

19. The system of claim 11, wherein the machine instructions further cause the processor to determine the boundary pixels using dilation and erosion to fit the smooth curve.

20. The system of claim wherein the machine instructions further cause the processor to fit the smooth curve by:
(a) generating a control polygon for a boundary, of a left ventricle in a ventriculogram, with labels corresponding to the anatomic landmarks;
(b) subdividing the control polygon to produce a subdivided polygon having an increased smoothness;
(c) rigidly aligning the subdivided polygon with the anatomic landmarks of the left ventricle; and
(d) fitting the subdivided polygon with the ED and ES image frames and the anatomic landmarks, to produce a reconstructed border of the left ventricle for ED and ES.
